(19) United States
(12) Patent Application Publication
(10) Pub. No.: US 2026/0204541 A1
(43) Pub. Date: Jul. 16, 2026

(54) METHOD FOR MANUFACTURING MIXED POWDER FOR DRY ELECTRODE AND METHOD FOR MANUFACTURING DRY ELECTRODE

(71) Applicants: Hyundai Motor Company, Seoul (KR); Kia Corporation, Seoul (KR)

(72) Inventors: Hannah Song, Hwaseong (KR); Youngsoo Lee, Hwaseong (KR); Hyunmook Hwang, Hawseong (KR)

(21) Appl. No.: 19/239,370

(22) Filed: Jun. 16, 2025

(30) Foreign Application Priority Data
Jan. 15, 2025 (KR) 10-2025-0005887

(51) Int. Cl. H01M 4/1391; H01M 4/04; H01M 4/525; H01M 4/62; H01M 4/02

(52) U.S. Cl. CPC H01M 4/1391; H01M 4/0435; H01M 4/0471; H01M 4/525; H01M 4/623; H01M 2004/021

(57) ABSTRACT

Provided is a method for manufacturing a mixed powder for a dry electrode and a method for manufacturing a dry electrode. The method for manufacturing a mixed powder for a dry electrode includes preparing a second mixture comprising an electrode active material and first binder particles, by mixing a first mixture comprising an electrode active material and a first binder starting material, wherein the mixing pulverizes the first binder starting material to form the first binder particles, increasing the temperature of the second mixture, and manufacturing a mixed powder for a dry electrode by adding a conductive material, a solid electrolyte, or a mixture thereof to the second mixture while maintaining the temperature. Also provided is a dry electrode manufactured according to the method.

### CROSS-REFERENCE TO RELATED APPLICATION

This present application claims under 35 U.S.C. § 119(a) the benefit of Korean Patent Application No. 10-2025-0005887, filed on January 15, 2025, in the Korean Intellectual Property Office, the entire disclosure of which is incorporated herein by reference.

### BACKGROUND

### TECHNICAL FIELD

The present disclosure relates to a method for manufacturing a mixed powder for a dry electrode, in which a conductive material or a solid electrolyte is well dispersed, a method for manufacturing a dry electrode, and a dry electrode manufactured according to the method.

### BACKGROUND

Lithium-ion batteries (LIBs) are commercially available lithium secondary batteries, which have safety issues due to flammable liquid electrolytes and limitations in energy density. To address these issues, all-solid-state batteries (ASSB), composed solely of solid components, are being actively researched. However, to implement all-solid-state batteries with performance equal to or better than existing lithium-ion batteries, several important issues must be resolved, such as improving ionic/electronic conductivity and electrochemical stability of solid electrolytes, optimizing electrode design, and reducing interfacial resistance.

Among these issues, regarding electrodes, to achieve high capacity in all-solid-state batteries, it is necessary to implement positive electrodes with high loading amounts of positive electrode active material. However, this has been difficult to achieve through existing wet processes. Accordingly, there have been attempts to manufacture positive electrodes through dry processes. However, dry processes make it difficult to manufacture electrodes of uniform thickness, and issues such as lifting of the binder have arisen.

### SUMMARY

The present disclosure is directed to providing a method for manufacturing a mixed powder for a dry electrode with significantly improved dispersibility of a conductive material or a solid electrolyte.

The present disclosure is further directed to providing a method for manufacturing a dry electrode with improved electrical conductivity by improving the dispersibility of a conductive material or a solid electrolyte.

The present disclosure is further directed to providing a method for manufacturing a dry electrode that may significantly improve the performance of secondary batteries.

An aspect of the present disclosure provides a method for manufacturing a mixed powder for a dry electrode, the method including preparing a second mixture comprising an electrode active material and first binder particles, by mixing a first mixture comprising an electrode active material and a first binder starting material, wherein the mixing pulverizes the first binder starting material to form the first binder particles, increasing the temperature of the second mixture, and manufacturing a mixed powder for a dry electrode by adding a conductive material, a solid electrolyte, or a mixture thereof to the second mixture while maintaining the temperature.

The mixing the first mixture may be performed at a speed of about 20 m/s to 50 m/s.

The ratio of the average particle diameter of the first binder particles to the average particle diameter of the electrode active material may be about 0.1 or less.

All or part of the first binder particles included in the second mixture may be located on the electrode active material.

The increasing the temperature of the second mixture may include increasing the temperature of the second mixture to a temperature at which the first binder particles melt.

The temperature at which the first binder particles melt may be lower than the melting point of the first binder particles.

The temperature of the second mixture may be increased by mixing at a speed of about 20 m/s to 50 m/s.

The increasing the temperature of the second mixture may include increasing the temperature of the second mixture to prepare a mixture including the electrode active material and a first binder layer located on the electrode active material and formed by melting of the first binder particles.

The conductive material, the solid electrolyte, or the mixture thereof may be located on the first binder layer.

The first binder starting material may include one or more resins or polymers of various types such as fluorinated resins, aromatic resins e.g. polystyrenes)m, polyacrylates, polyimides. More specifically, suitable binders may include e.g. at least one selected from the group consisting of polyvinylidene fluoride (PVDF), polyvinylidene fluoride-hexafluoropropylene (PVDF-HFP), polyacrylic acid (PAA), carboxymethyl cellulose (CMC), polyacrylic acid-carboxymethyl cellulose (PAA-CMC), polyethylene glycol (PEG), polypropylene glycol (PPG), polyethylene glycol dimethyl ether (PEGDME), and combinations thereof.

The method for manufacturing a mixed powder for a dry electrode may not use a solvent.

The first mixture may include the electrode active material and the first binder starting material in a weight ratio of 100:0.1 to 100:5.

The conductive material, the solid electrolyte, or the mixture thereof may be added in an amount of about 0.2 parts by weight to 10 parts by weight based on 100 parts by weight of the electrode active material.

Another aspect of the present disclosure provides a method for manufacturing a dry electrode, the method including preparing a second mixture comprising an electrode active material and first binder particles, by mixing a first mixture comprising an electrode active material and a first binder starting material, wherein the mixing pulverizes the first binder starting material to form the first binder particles, increasing the temperature of the second mixture, preparing a mixed powder for a dry electrode by adding a conductive material, a solid electrolyte, or a mixture thereof to the second mixture while maintaining the temperature, adding a second binder to the mixed powder for a dry electrode and preparing a fibrillated mixed powder under application of shear force, and rolling the fibrillated mixed powder to manufacture a dry electrode.

The second binder may include at least one selected from the group consisting of polytetrafluoroethylene (PTFE), polyethylene (PE), polyethylene oxide (PEO), and combinations thereof.

The second binder may be added in an amount of about 0.2 parts by weight to 10 parts by weight based on 100 parts by weight of the electrode active material.

In the mixed powder for a dry electrode manufactured according to the present disclosure, the conductive material or the solid electrolyte is highly uniformly distributed on the electrode active material.

In addition, the dry electrode manufactured according to the present disclosure may have significantly improved electrical conductivity by uniformly distributing the conductive material or solid electrolyte on the electrode active material.

Furthermore, the present disclosure may provide a method for manufacturing a dry electrode that may significantly improve the performance of secondary batteries.

In addition, a secondary battery including the dry electrode manufactured according to the present disclosure may have high capacity even at high charging and discharging rates.

As discussed, the method and system suitably include use of a controller or processer.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a scanning electron microscope (SEM) image of a mixed powder taken before adding a conductive material in Example 1.

FIG. 2 is a SEM image of the mixed powder taken after adding the conductive material in Example 1.

FIG. 3 is a SEM image of the mixed powder taken after adding the conductive material in Comparative Example 3.

FIG. 4 is a diagram showing the results of evaluating the rate capability of the manufactured secondary batteries, according to some embodiments of the present disclosure.

### DETAILED DESCRIPTION

Embodiments described in the present specification can be modified into various other forms, and the technology according to exemplary embodiments is not limited to the embodiments described below. The exemplary embodiments are provided to make the description of the present disclosure thorough and to fully convey the scope of the present disclosure to those skilled in the art.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In addition, numerical ranges used in this specification include all values between the lower and upper limits, all values incrementally derived logically within shape and breadth of the defined ranges, all double-limited values, and all possible combinations of upper and lower limits of differently limited numerical ranges. Unless specifically defined in this specification, values outside the defined numerical ranges that may occur due to experimental error or rounding off of values are also included within the defined numerical ranges.

As used herein, “dry electrode” refers to an electrode formed or manufactured substantially without using any solvent (organic or aqueous) during the mixing, binding, or coating steps.

As referred to herein, dry electrode technology or similar term can refer to essentially solventless or solventless (no solvent) manufacturing process for example that uses a dry mixture of battery components, like active materials, binders, and conductive additives, to create electrodes, instead of e.g. wet slurry methods that rely on solvents. In aspects, a dry electrode coating process may apply a dry (no or minimal solvent) mixture of active materials and conductive additives to the electrode substrate.

As used herein, “pulverizing” refers to reducing a material into small particles.

When a layer, film, area, or plate or the like is referred to as being “on” another layer, area, or plate, it may be directly on the other layer, film, area, or plate, or intervening layers, films, areas, or plates may be present therebetween.

Furthermore, terms including ordinals such as first, second, etc. may be used to describe various elements, but the elements are not limited by these terms. These terms are only used to distinguish one constituent element from another.

In the present specification, the average particle diameter means D50, and D50 means the diameter of particles corresponding to 50% of the cumulative distribution by volume. The average particle diameter may be derived from particle size distribution results analyzed using MICROTRAC's S3500 by taking samples according to ISO 13320-1 standard for the particles to be measured.

To improve the energy density of secondary batteries, there is a method of thickening the electrodes. However, thick-film electrodes were difficult to manufacture by wet processes, and when manufactured by dry processes, there were issues such as uneven electrode thickness and detachment of the binder. In addition, thick-film electrodes had the issue of lower high-rate charge-discharge capacity of cells due to longer electron and ion conduction channels. Accordingly, there is an urgent need for the development of a mixed powder for thick-film electrodes with improved dispersibility of conductive materials or solid electrolytes.

Various embodiments of the present disclosure relate to a method for manufacturing a mixed powder for a dry electrode with significantly improved dispersibility of a conductive material or a solid electrolyte.

In addition, various embodiments of the present disclosure relate to a method for manufacturing a dry electrode with improved electrical conductivity despite being a thick-film electrode by improving the dispersibility of a conductive material or a solid electrolyte. Secondary batteries to which such a dry electrode with improved electrical conductivity is applied may have significantly improved rate capability.

According to one embodiment of the present disclosure, a method for manufacturing a mixed powder for a dry electrode may include (S1) preparing a second mixture comprising an electrode active material and first binder particles, by mixing a first mixture comprising an electrode active material and a first binder starting material, wherein the mixing pulverizes the first binder starting material to form the first binder particles, (S2) increasing the temperature of the second mixture, and (S3) manufacturing a mixed powder for a dry electrode by adding a conductive material, a solid electrolyte, or a mixture thereof to the second mixture while maintaining the temperature.

The mixed powder for a dry electrode manufactured according to one embodiment may be applied to a dry electrode with improved electrical conductivity by including a conductive material and/or a solid electrolyte that are highly uniformly distributed on the electrode active material. In detail, the pulverized first binder particles may be uniformly dispersed on the electrode active material. By adding the conductive material and/or solid electrolyte to this second mixture in a heated state, the conductive material and/or solid electrolyte may be uniformly attached to the electrode active material by the uniformly dispersed first binder.

The method for manufacturing a mixed powder for a dry electrode according to one embodiment may further include, before S1, (S0) preparing the first mixture by mixing the electrode active material and the first binder starting material.

The mixing for preparing the first mixture in S0 is to evenly distribute the first binder starting material on the electrode active material before pulverizing the first binder starting material into first binder particles, and may be performed by known methods in the art. For example, the mixing in S0 may be performed by putting the materials into a mixer such as a blender, mill, mixer, ultrasonic mixer, or the like. The mixing in S0 may be performed at a speed of 1 m/s to 20 m/s, 1 m/s to 15 m/s, or 5 m/s to 10 m/s using a mixer. The mixing in S0 may be performed for 1 minute to 20 minutes or 5 minutes to 10 minutes at the above speed.

S1 is a process for preparing a second mixture including the electrode active material and the first binder particles formed by pulverization of the electrode active material and the first binder starting material by mixing the first mixture. Here, the first binder starting material refers to the original state of the binder material included in the first mixture, and the first binder particles may refer to a particulated form of the first binder formed through a pulverization process.

The mixing of the first mixture in S1 is for pulverizing the first binder starting material into first binder particles and may be performed by various methods without limitation as long as this is possible. For example, the mixing in S1 may be performed by putting the first mixture into a mixer such as a blender, mill, mixer, ultrasonic mixer, or the like. The mixing in S1 may be performed at a faster speed than the mixing in S0. Accordingly, strong collisions among the first binder starting material may occur, and the first binder particles may be formed through the pulverization process. The mixing in S1 may be performed at a speed of about 20m/s to 50 m/s or 25 m/s to 40 m/s using a mixer.

In S1, the first binder starting material is pulverized into the first binder particles by mixing, and when the first binder starting material is in particle form, it may have an average particle diameter of 0.5 μm to 10 μm but is not particularly limited thereto. The pulverized first binder particles may be pulverized to have an average particle diameter (D1) several to tens of times smaller than the average particle diameter (D2) of the electrode active material. Accordingly, the dispersibility of the first binder particles may be improved. In various aspects, the ratio (D1/D2) of the average particle diameter (D1) of the first binder particles to the average particle diameter (D2) of the electrode active material may be about 0.1 or less, or 0.05 or less. When the above range is satisfied, the first binder particles may be more uniformly dispersed on the electrode active material.

In S1, the average particle diameter (D2) of the electrode active material may be 0.1 μm to 20 μm or 1 μm to 10 μm. The electrode active material is not limited in form and may have a particle form of spherical, elliptical, plate-like, or irregular shape. However, as long as the electrode active material can be uniformly distributed together with the first binder particles, the average particle diameter and form of the electrode active material are not particularly limited to the above.

In S1, the average particle diameter (D1) of the first binder particles may be about 0.1 or less, or 0.05 or less of the average particle diameter (D2) of the electrode active material. For example, the average particle diameter (D1) of the first binder particles may be 5 nm to 500 nm or 50 nm to 400 nm. The first binder particles are not limited in form and may have a particle form of spherical, elliptical, plate-like, or irregular shape. However, as long as the first binder particles can be uniformly distributed together with the electrode active material, the average particle diameter and form of the first binder particles are not particularly limited to the above.

In S1, all or part of the first binder particles included in the second mixture may be located on the electrode active material. Thus, the dispersibility of the conductive material and/or solid electrolyte added as described below may be improved by the first binder. For example, all or part of the first binder particles may be attached to the surface of the electrode active material.

The electrode active material may be a positive electrode active material or a negative electrode active material.

The positive electrode active material is not particularly limited, but may be, for example, an oxide active material or a sulfide active material.

The oxide active material may include a layered rock-salt type active material such as LiCoO₂, LiMnO₂, LiNiO₂, LiVO₂, Li₁₊ₓNi_{1/3}Co_{1/3}Mn_{1/3}O₂, LiNi_{0.6}Mn_{0.2}Co_{0.2}O₂, Li(NiₐCo_{b}Mn_{c})O₂(a+b+c=1), a spinel-type active material such as LiMn₂O₄ or Li(Ni₀.₅Mn₁.₅)O₄, an inverse spinel-type active material such as LiNiVO₄ or LiCoVO₄, an olivine-type active material such as LiFePO₄, LiMnPO₄, LiCoPO₄, or LiNiPO₄0, a silicon-containing active material such as Li₂FeSiO₄ or Li₂MnSiO₄, a layered rock-salt type active material in which a portion of the transition metal is substituted with a different metal, such as LiNi_{0.8}Co_{(0.2-x)}AlₓO₂(0＜x＜0.2), a spinel-type active material in which a portion of the transition metal is substituted with a different metal, such as Li₁₊ₓMn_{2-x-y}M_{y}O₄ (where M is at least one selected from Al, Mg, Co, Fe, Ni, and Zn, and 0 < x + y < 2), or a lithium titanate such as Li₄Ti₅O₁₂, but is not limited thereto.

The sulfide active material may include copper chevrel, iron sulfide, cobalt sulfide, nickel sulfide, and the like.

The negative electrode active material is not particularly limited, but may be, for example, a carbon active material or a metal active material.

The carbon active material may be graphite, such as mesocarbon microbeads (MCMB) or highly oriented pyrolytic graphite (HOPG), or amorphous carbon, such as hard carbon and soft carbon.

The metal active material may be one or more of In, Al, Si, Sn, and alloys containing one or more of these elements.

The first binder starting material may include at least one selected from the group consisting of polyvinylidene fluoride (PVDF), polyvinylidene fluoride-hexafluoropropylene (PVDF-HFP), polyacrylic acid (PAA), carboxymethyl cellulose (CMC), polyacrylic acid-carboxymethyl cellulose (PAA-CMC), polyethylene glycol (PEG), polypropylene glycol (PPG), polyethylene glycol dimethyl ether (PEGDME), and combinations thereof.

In S1, the first mixture may include the electrode active material and the first binder starting material in a weight ratio of 100:0.1 to 100:5. In various aspects, the weight ratio of the electrode active material and the first binder starting material may be 100:0.1 to 100:3 or 100:0.1 to 100:2, but is not particularly limited thereto.

S2 is a process for increasing the temperature of the second mixture. S2 may include increasing the temperature of the second mixture to a temperature at which the first binder particles melt. As the uniformly distributed first binder particles melt, the dispersibility and adhesiveness of the conductive material and/or solid electrolyte added as described below may be further improved.

In S2, the temperature of the second mixture may be increased by mixing using a mixer. The mixer may be a blender, mill, mixer, ultrasonic mixer, etc., but is not particularly limited thereto. The temperature of the second mixture may be increased by continuing the mixing by the mixer for a predetermined time.

When the temperature is increased by mixing the second mixture with a mixer, the temperature at which the first binder particles melt due to collisions between particles included in the second mixture may be lower than the melting point of the first binder particles. For example, the first binder particles may melt at a temperature 50°C or more, 70°C or more, or 85°C or more lower than the normal melting point of the material itself, but this may vary depending on the mixing conditions (speed, time, etc.).

In S2, the temperature of the second mixture may be increased to 50°C to 150°C or 70°C to 120°C. However, this may vary depending on the type of the first binder, mixing conditions (speed, time, etc.), and the like.

In S2, the temperature of the second mixture may be increased by mixing at a speed of about 20 m/s to 50 m/s or 25 m/s to 40 m/s. In various aspects, the temperature of the second mixture may be increased by mixing at the above range of speed for 5 minutes to 60 minutes, 5 minutes to 40 minutes, or 10 minutes to 30 minutes. However, the mixing speed and time are not particularly limited as long as the first binder particles can be melted.

S1 and S2 may be performed continuously by mixing using a mixer. In detail, at the beginning of the mixing, the first binder starting material is pulverized into first binder particles, and when maintaining the mixing speed for a predetermined time, the temperature rises, and the first binder particles may melt. For example, S1 and S2 may be performed by mixing at a speed of about 20 m/s to 50 m/s or 25 m/s to 40 m/s for a period of 5 minutes to 60 minutes, 5 minutes to 40 minutes, or 10 minutes to 30 minutes. There is an advantage in terms of process as it can be performed only by the mixing process without a separate heating process.

S2 may include increasing the temperature of the second mixture to prepare a mixture including the electrode active material and a first binder layer located on the electrode active material and formed by melting the first binder particles. The first binder layer may be formed from the first binder particles uniformly dispersed on the electrode active material. Due to this first binder layer, the conductive material and/or solid electrolyte added as described below may be uniformly dispersed and attached to the electrode active material.

S3 is a process for preparing the mixed powder for a dry electrode by adding a conductive material, a solid electrolyte, or a mixture thereof to the second mixture while maintaining the temperature. Accordingly, the conductive material and/or solid electrolyte is added in a state in which the first binder particles are melted, allowing the conductive material and/or solid electrolyte to be attached to the electrode active material with higher dispersibility and adhesiveness. Here, the term “increased temperature conditions” may refer to a state in which the temperature is stably maintained within a temperature range of ±10°C or ±5°C from the increased temperature achieved in S2.

In S3, the addition of the conductive material, solid electrolyte, or a mixture thereof may be performed at the temperature at which the first binder particles melt in S2. For example, the addition of the conductive material, solid electrolyte, or a mixture thereof may be performed at a temperature lower than the melting point of the first binder particles. For example, the conductive material, solid electrolyte, or a mixture thereof may be added at a temperature 50°C or more, 70°C or more, or 85°C or more lower than the melting point of the first binder particles. As a non-limiting example, the conductive material, solid electrolyte, or a mixture thereof may be added at 50°C to 150°C, 70°C to 120°C, 80°C to 100°C, or 85°C to 95°C. However, this may vary depending on the type of the first binder, the conditions under which the first binder is melted, or the like.

In S3, the increased temperature may be maintained by continuing the method used to increase the temperature in S2. For example, if the temperature was increased by mixing in S2, the conductive material, solid electrolyte, or a mixture thereof may be added while maintaining those mixing conditions. S3 may include adding the conductive material, solid electrolyte, or a mixture thereof while mixing at a speed of about 20 m/s to 50 m/s or 25 m/s to 40 m/s.

In another embodiment, by adding the conductive material, solid electrolyte, or a mixture thereof immediately after completing the method of increasing the temperature in S2, the conductive material, solid electrolyte, or a mixture thereof may be added under the increased temperature conditions.

In S3, the conductive material, solid electrolyte, or a mixture thereof may be located on the first binder layer. Thus, the conductive material and/or solid electrolyte may be uniformly dispersed and attached to the electrode active material. Accordingly, a dry electrode using the manufactured mixed powder for a dry electrode may have improved electrical conductivity.

The method for manufacturing a mixed powder for a dry electrode according to one embodiment may further include, after S3, cooling the mixed powder for a dry electrode. The cooling of the mixed powder for a dry electrode may be performed until the temperature of the mixed powder for a dry electrode drops to 15°C to 25°C. Here, the cooling may be performed by known methods in the art. For example, if a mixer such as a blender, mill, mixer, ultrasonic mixer, or the like was used to perform the previous processes, the mixer's speed may be set to low to allow cooling. In various aspects, the cooling of the mixed powder for a dry electrode may be performed at a speed of 1 m/s to 20 m/s, 1 m/s to 15 m/s, or 5 m/s to 10 m/s using a mixer until the temperature of the mixed powder for a dry electrode or the mixer drops to 15°C to 25°C.

The conductive material or solid electrolyte added in S3 may be used without limitation as long as it is a known material in the art.

The conductive material may be a sp² carbon material such as carbon black, conducting graphite, ethylene black, or carbon nanotubes, or graphene.

The solid electrolyte may be a sulfide-based solid electrolyte. The sulfide-based solid electrolyte may be Li₂S-P₂S₅, Li₂S-P₂S₅-LiI, Li₂S-P₂S₅-LiCl, Li₂S-P₂S₅-LiBr, Li₂S-P₂S₅-Li₂O, Li₂S-P₂S₅-Li₂O-LiI, Li₂S-SiS₂, Li₂S-SiS₂-LiI, Li₂S-SiS₂-LiBr, Li₂S-SiS₂-LiCl, Li₂S-SiS₂-B₂S₃-LiI, Li₂S-SiS₂-P₂S₅-LiI, Li₂S-B₂S₃, Li₂S-P₂S₅-ZₘSₙ (where m and n are positive numbers, and Z is one of Ge, Zn, Ga), Li₂S-GeS₂, Li₂S-SiS₂-Li₃PO₄, Li₂S-SiS₂-LiₓMO_{y} (where x and y are positive numbers, and M is one of P, Si, Ge, B, Al, Ga, In), Li₁₀GeP₂S₁₂, etc.

The conductive material, solid electrolyte, or a mixture thereof may be added in an amount of about 0.2 parts by weight to 10 parts by weight or 0.2 parts by weight to 5 parts by weight based on 100 parts by weight of the electrode active material.

The method for manufacturing a mixed powder for a dry electrode according to one embodiment may not use a solvent in S1, S2 and S3. By manufacturing the mixed powder for a dry electrode under dry conditions in S1, S2 and S3, the formation of defects such as pinholes or cracks on the electrode film may be prevented. In addition, there is an advantage in terms of process in that the process of drying the solvent can be omitted.

The mixed powder for a dry electrode manufactured according to the method for manufacturing a mixed powder for a dry electrode according to one embodiment may be used to manufacture dry electrodes with improved electrical conductivity even when the content of the electrode active material is high. For example, the mixed powder for a dry electrode may comprise 80parts by weight to 99.5 parts by weight of the electrode active material, 0.1 parts by weight to 5 parts by weight of the first binder, and 0.1 parts by weight to 10 parts by weight of the conductive material, solid electrolyte, or a mixture thereof. In various aspects, the mixed powder for a dry electrode may comprise 90 parts by weight to 99.5 parts by weight of the electrode active material, 0.1 parts by weight to 3 parts by weight of the first binder, and 0.1 parts by weight to 5 parts by weight of the conductive material, solid electrolyte, or a mixture thereof.

According to another embodiment of the present disclosure, the method for manufacturing a dry electrode may include (S1) preparing a second mixture comprising an electrode active material and first binder particles, by mixing a first mixture comprising an electrode active material and a first binder starting material, wherein the mixing pulverizes the first binder starting material to form the first binder particles, (S2) increasing the temperature of the second mixture, (S3) preparing a mixed powder for a dry electrode by adding a conductive material, a solid electrolyte, or a mixture thereof to the second mixture while maintaining the temperature, (S4) adding a second binder to the mixed powder for a dry electrode and preparing a fibrillated mixed powder under application of shear force, and (S5) rolling the fibrillated mixed powder to manufacture a dry electrode.

A dry electrode manufactured according to one embodiment may have improved electrical conductivity by including a conductive material and/or solid electrolyte highly uniformly distributed on the electrode active material. In addition, secondary batteries to which the dry electrode is applied may have significantly improved rate capability. In detail, the pulverized first binder particles may be uniformly dispersed on the electrode active material. By adding the conductive material and/or solid electrolyte to this second mixture in a heated state, the conductive material and/or solid electrolyte may be uniformly attached to the electrode active material by the uniformly dispersed first binder. Accordingly, a dry electrode using the mixed powder for a dry electrode with improved dispersibility may have improved electrical conductivity.

Since content described above may be applied for S1, S2 and S3, a detailed explanation thereof is omitted.

S4 is a process for adding a second binder to the mixed powder for a dry electrode and preparing a fibrillated mixed powder under application of shear force by. Here, the application of shear force may be performed by known methods in the art. For example, if a mixer such as a blender, mill, mixer, ultrasonic mixer, or the like was used to perform the previous processes, the mixer's speed may be set to high to apply shear force. In various aspects, the application of shear force may be performed by rotating a mixer at a speed of about 20 m/s to 50 m/s or 25 m/s to 40 m/s. For example, the shear force may be applied by rotating at the above range of rotation speed for 5 minutes to 60 minutes, 5 minutes to 40 minutes, or 10 minutes to 30 minutes.

S4 may include preparing the fibrillated mixed powder under application of shear force after adding and dispersing the second binder to the mixed powder for a dry electrode. Here, the dispersion of the second binder may be performed by known methods in the art. For example, if a mixer such as a blender, mill, mixer, ultrasonic mixer, or the like was used to perform the previous processes, the mixer's speed may be set to low to uniformly disperse the second binder together with the mixed powder for a dry electrode. For example, the second binder may be uniformly dispersed by mixing with a mixer at a speed of 1 m/s to 20 m/s, 1 m/s to 15 m/s, or 5 m/s to 10 m/s for 1 minute to 20 minutes or 5 minutes to 10 minutes.

The method for manufacturing a dry electrode according to one embodiment may further include, after S4, cooling the fibrillated mixed powder. The cooling of the fibrillated mixed powder may be performed until the temperature of the fibrillated mixed powder drops to 15°C to 25°C. Here, the cooling may be performed by known methods in the art. For example, if a mixer such as a blender, mill, mixer, ultrasonic mixer, or the like was used to perform the previous processes, the mixer's speed may be set to low to allow cooling. For example, the cooling of the fibrillated mixed powder may be performed using a mixer at a speed of 1 m/s to 20 m/s, 1 m/s to 15 m/s, or 5 m/s to 10 m/s until the temperature of the fibrillated mixed powder or the mixer drops to 15°C to 25°C.

The second binder added in S4 may be used without limitation as long as it is a binder that can be fibrillated under application of shear force. The second binder may include at least one selected from the group consisting of polytetrafluoroethylene (PTFE), polyethylene (PE), polyethylene oxide (PEO), and combinations thereof.

The second binder may be added in an amount of about 0.2 parts by weight to 10 parts by weight or 0.2 parts by weight to 5 parts by weight based on 100 parts by weight of the electrode active material.

S5 is a process for rolling the fibrillated mixed powder to manufacture the dry electrode. S5 may include preparing an electrode film by rolling the fibrillated mixed powder and attaching the electrode film to one side of a current collector. The rolling of the fibrillated mixed powder may be performed by known methods in the art. For example, the electrode may be manufactured by using a pair of rollers or by applying pressure with a press machine, etc.

The method for manufacturing a dry electrode according to one embodiment may not use a solvent in S1 to S5. By manufacturing the dry electrode under dry conditions in S1 to S5, the formation of defects such as pinholes or cracks on the electrode film can be prevented. In addition, there is an advantage in terms of process in that the process of drying the solvent can be omitted.

A dry electrode manufactured according to the method for manufacturing a dry electrode according to one embodiment may include a current collector and an electrode film located on the current collector, and the electrode film may include a fibrillated composite. The fibrillated composite may include (a) an electrode active material, (b) a first binder, (c) a conductive material, a solid electrolyte, or a mixture thereof, and (d) a fibrillated second binder. The first binder performs the role of making the conductive material, solid electrolyte, or a mixture thereof adhere to the electrode active material, and the second binder performs the role of connecting unit materials composed of the electrode active material, the first binder, and the conductive material, solid electrolyte, or a mixture thereof by being fibrillated. Since the electrode active material, first binder, conductive material, solid electrolyte, and second binder have been described above, detailed explanations thereof are omitted.

The dry electrode may have improved electrical conductivity even when the loading amount of the electrode active material is high. Also, a dry electrode with significantly improved electrical conductivity may be manufactured even if it is thickened. Accordingly, secondary batteries to which the dry electrode is applied have the advantage of improved rate capability. For example, the loading amount of the electrode active material in the dry electrode may be 10 mg/cm² or more, 20 mg/cm² or more, 25 mg/cm² or more, or 28 mg/cm² or more. The upper limit of the electrode active material loading amount may be 50 mg/cm² or less or 40 mg/cm² or less but is not limited thereto.

The dry electrode may comprise 80 parts by weight to 99.5 parts by weight of the electrode active material, 0.1 parts by weight to 5 parts by weight of the first binder, 0.1 parts by weight to 10 parts by weight of the conductive material, solid electrolyte, or a mixture thereof, and 0.1 parts by weight to 5 parts by weight of the second binder. For example, the dry electrode may comprise 90 parts by weight to 99.5 parts by weight of the electrode active material, 0.1 parts by weight to 3 parts by weight of the first binder, 0.1 parts by weight to 5 parts by weight of the conductive material, solid electrolyte, or a mixture thereof, and 0.1 parts by weight to 5 parts by weight of the second binder.

Hereinafter, examples and experimental examples will be specifically illustrated and described below. However, the following examples and experimental examples are only illustrative, and the technology described in this specification is not limited thereto.

### Example 1

### Preparation of Mixed Powder for Dry Electrode

After putting 9.6 kg of lithium nickel manganese cobalt oxide (LiNi_{0.6}Mn_{0.2}Co_{0.2}O₂) as the positive electrode active material and 0.05 kg of polyacrylic acid-carboxymethyl cellulose (PAA-CMC) as the first binder into a powder mixer consisting of a rotor and a vessel, the mixer was rotated at a rotation speed of 10 m/s for 5 minutes. Then, the mixer was rotated at 25 m/s for 30 minutes. During the 30 minutes of rotation, the temperature inside the mixer gradually increased and was measured at a maximum of 90°C. Immediately after completing the 30 minutes of rotation, 0.2 kg of carbon black as a conductive material was put into the mixer to prepare a mixed powder for a dry electrode. After the addition, the mixer was rotated at a rotation speed of 5 m/s while cooling the vessel. It was cooled until it reached room temperature (20°C).

### Preparation of Dry Electrode

After putting 0.15 kg of polytetrafluoroethylene (PTFE) as the second binder into the mixer containing the mixed powder for a dry electrode, the mixer was rotated at a rotation speed of 10 m/s for 5 minutes, and shear force was applied for 30 minutes at a rotation speed of 35 m/s to obtain a fibrillated mixed powder. Then, the mixer was rotated at a rotation speed of 5 m/s until it reached room temperature (20°C). The cooled fibrillated mixed powder was roll-pressed to form an electrode film and attached to an aluminum (Al) foil to manufacture a dry electrode. The electrode loading amount was 30 mg/cm².

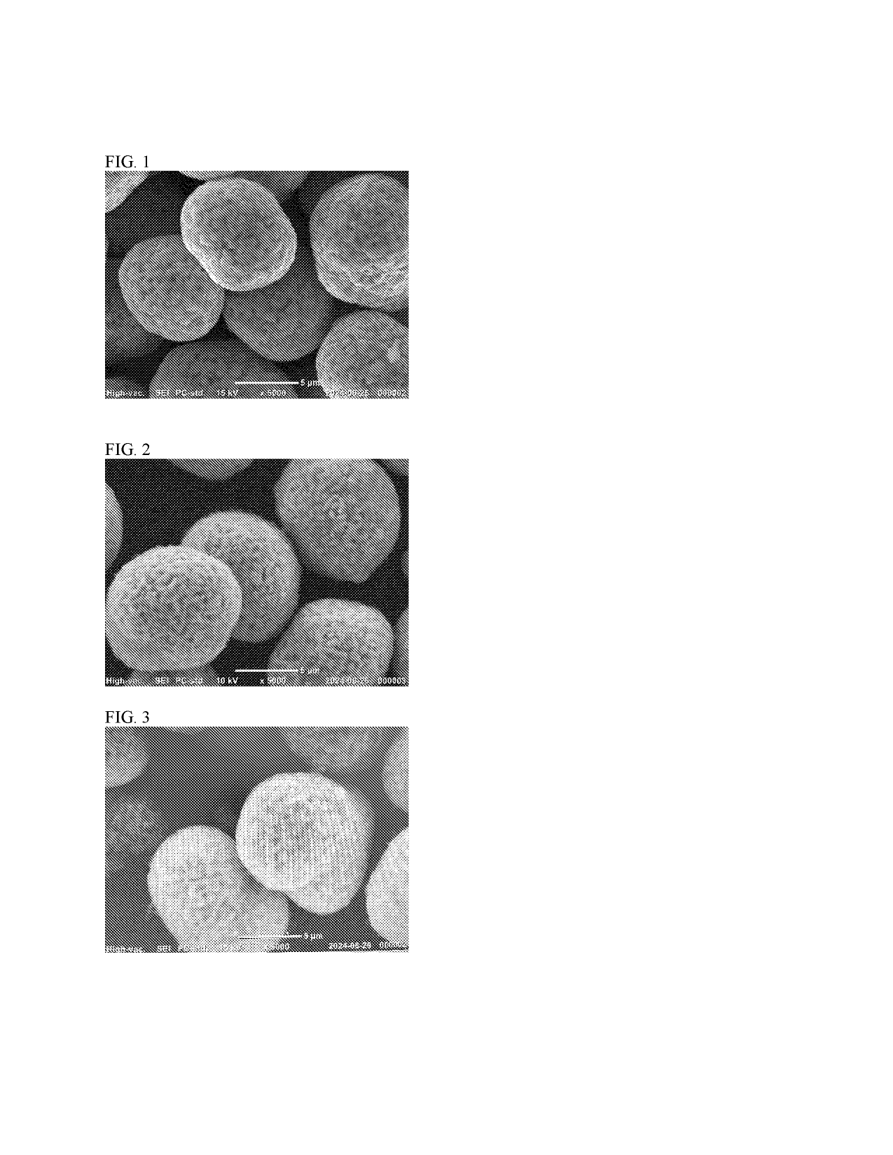

To confirm the dispersibility of the first binder and the conductive material, SEM images were taken before and after adding the conductive material during the preparation of the mixed powder for a dry electrode, and the results are shown in FIGS. 1 and 2. Referring to FIG. 1, it can be seen that the first binder particles were melted and uniformly distributed and attached to the surface of the positive electrode active material. Referring to FIG. 2, it can be seen that the conductive material was uniformly distributed and attached to the surface of the positive electrode active material by the melted first binder.

### Example 2

In the process for preparing a mixed powder for a dry electrode, the mixed powder for an electrode was prepared in the same way as Example 1 except that it was rotated at 40 m/s instead of 25 m/s. In addition, SEM images were taken before and after adding the conductive material during the preparation of the mixed powder for a dry electrode. As a result, similar to FIGS. 1 and 2, it was confirmed that the melted first binder particles and conductive material were uniformly distributed and attached to the surface of the positive electrode active material.

### Comparative Example 1

9.6 kg of lithium nickel manganese cobalt oxide (LiNi_{0.6}Mn_{0.2}Co_{0.2}O₂) as the positive electrode active material, 0.2 kg of carbon black as the conductive material, and 0.2 kg of polytetrafluoroethylene (PTFE) as the second binder were put into a powder mixer consisting of a rotor and a vessel. Subsequently, the mixer was rotated at a rotation speed of 10 m/s for 5 minutes, and shear force was applied for 30 minutes at a rotation speed of 35 m/s to obtain a fibrillated mixed powder. Then, while cooling the vessel, the mixer was rotated at a rotation speed of 5 m/s. It was cooled until it reached room temperature (20°C). The cooled fibrillated mixed powder was roll-pressed to form an electrode film and attached to an aluminum (Al) foil to manufacture a dry electrode. The electrode loading amount was 30 mg/cm².

### Comparative Example 2

A positive electrode slurry was prepared by adding 9.6 kg of lithium nickel manganese cobalt oxide (LiNi_{0.6}Mn_{0.2}Co_{0.2}O₂) as the positive electrode active material, 0.2 kg of carbon black as the conductive material, and 0.2 kg of polyvinylidene fluoride (PVDF) as a binder to N-methyl-2-pyrrolidone (NMP) as a solvent. The prepared slurry was coated on a 12μm thick aluminum (Al) foil, dried at a temperature of 120°C, and then roll-pressed to produce a 140μm thick positive electrode. The electrode loading amount was 30 mg/cm².

### Comparative Example 3

In the process for preparing a mixed powder for a dry electrode, the mixed powder for an electrode was prepared in the same way as Example 1 except that it was rotated at 15 m/s instead of 25 m/s.

To confirm the dispersibility of the conductive material, an SEM image was taken after adding the conductive material during the preparation of the mixed powder for a dry electrode, and the result is shown in FIG. 3. Referring to FIG. 3, the conductive agent was observed to be in an agglomerated state and not well dispersed. This is judged to be because the conductive material was added while the first binder particles were not melted, and thus the conductive material did not adhere well to the surface of the positive electrode active material.

### Comparative Example 4

After putting 9.6 kg of lithium nickel manganese cobalt oxide (LiNi_{0.6}Mn_{0.2}Co_{0.2}O₂) as the positive electrode active material and 0.05 kg of polyacrylic acid-carboxymethyl cellulose (PAA-CMC) as the first binder into a powder mixer consisting of a rotor and a vessel, the mixer was rotated at a rotation speed of 10 m/s for 5 minutes. Then, the mixer was rotated at 25 m/s for 30 minutes. During the 30 minutes of rotation, the temperature inside the mixer gradually increased and was measured at a maximum of 90°C. Immediately after completing the 30 minutes of rotation, 0.2 kg of carbon black as the conductive material was put into the mixer to prepare a mixed powder for a dry electrode. After the addition, the mixer was rotated at a rotation speed of 5 m/s while cooling the vessel. It was cooled until it reached room temperature (20°C).

An SEM image was taken after adding the conductive material during the preparation of the mixed powder for a dry electrode. As a result, similar to FIG. 3, the conductive agent was observed to be in an agglomerated state and not well dispersed. This is judged to be because the conductive material was added after the melted first binder particles were cooled to room temperature, and thus the conductive material did not adhere well to the surface of the positive electrode active material.

### Experimental Example Evaluation of Rate Capability

Coin cells were prepared using the electrodes manufactured in Example 1, Comparative Example 1, and Comparative Example 2. In detail, each electrode manufactured in Example 1, Comparative Example 1, and Comparative Example 2 was punched into a circular shape and placed in the bottom case of a coin cell, and a separator and a lithium metal negative electrode were sequentially placed on top of the electrode. After injecting the electrolyte and placing a disk and a spring, the top case of the coin cell was closed and crimped. The coin cell was moved to a constant temperature chamber for the rate capability evaluation below.

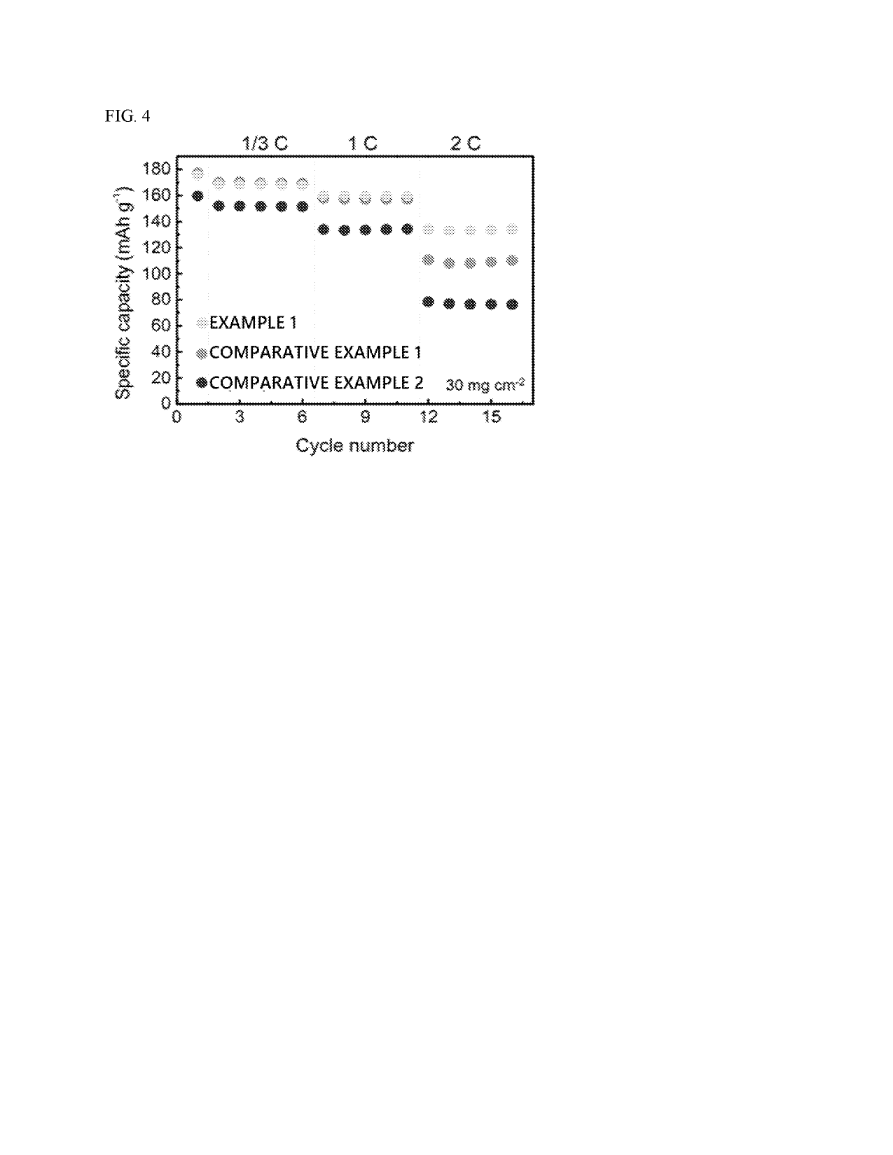

To evaluate the rate capability, charging was conducted in a CC/CV method (3.0-4.4V, 1/20C cut-off) at 25°C, and discharging was performed under conditions of 6 cycles at 1/3C, 5 cycles at 1C, and 5 cycles at 2C. The discharge capacity of each cycle was measured to analyze the rate capability. FIG. 4 is a diagram showing the results of evaluating the rate capability of the manufactured coin cells. Referring to FIG. 4, the coin cell applying the dry electrode of Example 1 had excellent capacity at high C-rates. On the other hand, the coin cell applying the dry electrode of Comparative Example 1 manufactured without the first binder had similar capacity to Example 1 at low C-rates but significantly reduced capacity at high C-rates. In addition, the coin cell with the wet electrode of Comparative Example 2 had lower capacity than Example 1 at all C-rates. Through this, it can be seen that the dry electrode according to one embodiment may have improved electrical conductivity due to the uniform distribution of the conductive material, etc. on the electrode active material, and secondary batteries using such a dry electrode may have significantly improved rate capability.

Although the scope of the present disclosure has been described by specific matters and limited embodiments in the present specification, the embodiments are provided only for assisting the understanding of the present disclosure more generally, and the present disclosure is not limited to the embodiments disclosed herein. Various modifications and changes may be made to the embodiments by those skilled in the art to which the present disclosure pertains from the description and shall be understood as being included in the embodiments disclosed herein.

What is claimed is:

1. A method for manufacturing a mixed powder for a dry electrode, the method comprising:
preparing a second mixture comprising an electrode active material and first binder particles, by mixing a first mixture comprising an electrode active material and a first binder starting material,
wherein the mixing pulverizes the first binder starting material to form the first binder particles;
increasing a temperature of the second mixture; and
manufacturing a mixed powder for a dry electrode by adding a conductive material, a solid electrolyte, or a mixture thereof to the second mixture while maintaining the temperature.

2. The method according to claim 1, wherein the mixing of the first mixture is performed at a speed of about 20 m/s to 50 m/s.

3. The method according to claim 1, wherein a ratio of an average particle diameter of the first binder particles to an average particle diameter of the electrode active material is about 0.1 or less.

4. The method according to claim 1, wherein all or part of the first binder particles included in the second mixture are located on the electrode active material.

5. The method according to claim 1, wherein the increasing the temperature of the second mixture comprises increasing the temperature of the second mixture to a temperature at which the first binder particles melt.

6. The method according to claim 5, wherein the temperature at which the first binder particles melt is lower than a melting point of the first binder particles.

7. The method according to claim 1, wherein the temperature of the second mixture is increased by mixing at a speed of about 20 m/s to 50 m/s.

8. The method according to claim 1, wherein the increasing the temperature of the second mixture comprises preparing a mixture comprising the electrode active material and a first binder layer located on the electrode active material and formed by melting of the first binder particles by increasing the temperature of the second mixture.

9. The method according to claim 8, wherein the conductive material, the solid electrolyte, or the mixture thereof is located on the first binder layer.

10. The method according to claim 1, wherein the first binder starting material comprises at least one selected from the group consisting of polyvinylidene fluoride (PVDF), polyvinylidene fluoride-hexafluoropropylene (PVDF-HFP), polyacrylic acid (PAA), carboxymethyl cellulose (CMC), polyacrylic acid-carboxymethyl cellulose (PAA-CMC), polyethylene glycol (PEG), polypropylene glycol (PPG), polyethylene glycol dimethyl ether (PEGDME), and combinations thereof.

11. The method according to claim 1, wherein no solvent is used.

12. The method according to claim 1, wherein the first mixture comprises the electrode active material and the first binder starting material in a weight ratio of about 100:0.1 to 100:5.

13. The method according to claim 1, wherein the conductive material, the solid electrolyte, or the mixture thereof is added in an amount of about 0.2 parts by weight to 10 parts by weight based on 100 parts by weight of the electrode active material.

14. A method for manufacturing a dry electrode, the method comprising:
preparing a second mixture comprising an electrode active material and first binder particles, by mixing a first mixture comprising an electrode active material and a first binder starting material,
wherein the mixing pulverizes the first binder starting material to form the first binder particles;
increasing the temperature of the second mixture;
preparing a mixed powder for a dry electrode by adding a conductive material, a solid electrolyte, or a mixture thereof to the second mixture while maintaining the temperature;
adding a second binder to the mixed powder for a dry electrode and preparing a fibrillated mixed powder under application of shear force; and
rolling the fibrillated mixed powder to manufacture a dry electrode.

15. The method according to claim 14, wherein the second binder comprises at least one selected from the group consisting of polytetrafluoroethylene (PTFE), polyethylene (PE), polyethylene oxide (PEO), and combinations thereof.

16. The method according to claim 14, wherein the second binder is added in an amount of about 0.2 parts by weight to 10 parts by weight based on 100 parts by weight of the electrode active material.

17. A dry electrode comprising:
an electrode active material;
a first binder layer, located on the electrode active material, formed by melting first binder particles under an increased temperature condition;
a conductive material, a solid electrolyte, or a mixture thereof, located on the first binder layer; and
a fibrillated second binder,
wherein the dry electrode is manufactured under conditions in which no solvent is used, and the dry electrode is obtained by:
preparing a second mixture comprising the electrode active material and the first binder particles, by mixing a first mixture comprising the electrode active material and a first binder starting material,
wherein the mixing pulverizes the first binder starting material to form the first binder particles;
increasing a temperature of the second mixture to melt the first binder particles and form said first binder layer on the electrode active material;
adding the conductive material, the solid electrolyte, or the mixture thereof to the second mixture while maintaining the temperature so that said conductive material, solid electrolyte, or mixture thereof is located on the first binder layer; and
adding the second binder to the second mixture and fibrillating the second binder under application of shear force, thereby producing a fibrillated mixed powder that is roll-pressed or otherwise formed into the dry electrode.

18. The dry electrode according to claim 17, wherein an electrode loading amount of the electrode active material is about 10 mg/cm² or more up to about 50 mg/cm².

19. The dry electrode according to claim 17, wherein the second binder comprises at least one selected from the group consisting of polytetrafluoroethylene (PTFE), polyethylene (PE), and polyethylene oxide (PEO), and is added in an amount of about 0.2 parts by weight to 10 parts by weight, based on 100 parts by weight on the electrode active material.

20. The dry electrode according to claim 17, wherein the fibrillated second binder is formed by applying shear force at a speed of about 10 rpm to 35 rpm for about 5 minutes to 60 minutes, while the temperature of the second mixture is maintained at or above the melting point of the first binder particles.
